(19) United States
(12) Patent Application Publication
(10) Pub. No.: US 2013/0168456 A1
(43) Pub. Date: Jul. 4, 2013

(54) Method for controlling relative air humidity in pianos and other small enclosed areas

(71) Applicant: Matthias Eduard Zenkel, Fuerstenzell (DE)

(72) Inventor: Matthias Eduard Zenkel, Fuerstenzell (DE)

(21) Appl. No.: 13/711,285

(22) Filed: Dec. 11, 2012

(30) Foreign Application Priority Data
Dec. 12, 2011 (DE) 10 2011 120 733

(51) Int. Cl. G05D 22/02

(52) U.S. Cl. CPC G05D 22/02
USPC 236/44 A

(57) ABSTRACT

A method for controlling air humidity in pianos and other small enclosed areas consists of a hygrostat, at least one humidifier and/or dehumidifier and at least one blower producing a continuous air stream. The humidifier and the dehumidifier are airtight containers, each coupled to another blower, forwarding air through the respective container. The hygrostat regulates the level of air humidity by controlling the blowers attached to the humidifier and dehumidifier, respectively. The humidified or dehumidified air is distributed throughout the piano by the continuous air stream. Thus air humidity in pianos can be kept in a range of ±1% and the maintenance interval is only about every 12 month. In grand pianos the open end at the bottom is covered with a moisture impervious sheet and another blower enables the control of air humidity in the area occupied by the action for the first time.

### REFERENCES CITED

1) U.S. Pat. No. 6,133,519
2) Thomas Trübswetter, Holztrocknung: Verfahren zur Trocknung von Schnittholz—Planung von Trocknungsanlagen, Carl Hanser Verlag, 2., aktualisierte Auflage, 6, Aug. 2009, page 25.

### BACKGROUND

### Discussion of Prior Art

It's a well-known fact that variations in air humidity cause pianos to get out of tune. The voicing of the hammer heads gets muffled, when air humidity is high and sharp, when air humidity is low. It's also a matter of fact, that pianos may get damaged, when air moisture stays at very high or very low values. Thus the durability of pianos, just as the stability of its tuning and the voicing of its hammer heads is increased, when the humidity inside pianos is controlled at both high and low humidity of the surrounding air.

This can be achieved by controlling humidity in the whole room, which contains the piano. Another, energy saving possibility is to attach the Piano Life Saver™-system from Dampp Chaser Electronics in Hendersonville, N.C. By using this system in an upright piano, I recognized that there is an excess of humidification/dehumidification, because heater tubes are used both for humidification and for dehumidification. Dehumidification, for example, is achieved by switching on a heater tube. Thus the air inside the piano is heated and relative air humidity therefore decreases. When the reference value of humidity is reached, the heater rod will be switched off. But until the tube has cooled down completely, the air still gets dried. The same is true for the humidifier, because in this case another heater rod heats a wet sheet of water absorbing material and thus vaporizes water for some time even after being switched off. So I often found both heater rods being warm, indicating that they run alternately to compensate the excess of each other. This causes excess energy costs and water consumption. Furthermore water of the humidifier evaporates permanently, since the water is supplied to the sheet of water absorbing material by an open container without lid. Thus the maintenance interval is further reduced. I have found that the maintenance interval for the refilling of the humidifier of the Piano Life Saver™-system in my upright piano is about two weeks in winter and about four weeks in summer. This short interval may cause trouble, when a journey is intended, for example.

In addition, to date no system is known, which is able to keep constant the humidity in the area, occupied by the action of grand pianos.

### SUMMARY

In one embodiment, inside a piano a humidifier and a dehumidifier, each consist of an airtight container with one air inlet and one air outlet. A fan is attached to each air inlet, forwarding air through the respective container, operated by a hygrostat split to the second. A blower is attached nearby the humidifier and dehumidifier generating a continuous air stream throughout the piano. The humidified and dehumidified air, respectively thus is distributed throughout the piano. In this way the swing of air humidity inside the piano amounts to only ±1% and the maintenance interval is extended to about one year.

In another embodiment the open end at the bottom of a grand piano is covered with a moisture impervious sheet and additionally another blower generates an air stream through a connection of the area below the soundboard and the area occupied by the action. Thus it is possible to control air humidity in the area occupied by the action of grand pianos.

### ADVANTAGES

Accordingly several advantages of one or more aspects are as follows: that there is no excess humidification or dehumidification after the reference value is reached, that humidity can be controlled in a range of ±1%, that energy consumption is reduced, that the maintenance interval is strongly extended, that the humidity in the area occupied by the action in grand pianos is controlled, and that the voicing of the hammer heads remains unchanged. These and other advantages of one or more aspects will be apparent of the drawings and ensuing descriptions.

### BRIEF DESCRIPTION OF THE DRAWING

FIG. 1 is a schematic side view of a first embodiment in an upright piano.

FIG. 2 is a schematic front view of a first embodiment in an upright piano.

FIG. 3 is an exploded view of the humidifier used in a first embodiment.

FIG. 4 is a schematic side view of a grand piano.

FIG. 5 is an exploded view of the humidifier used in the second embodiment.

FIG. 6 is a schematic bottom view of a second embodiment in a grand piano.

FIG. 7 is an exploded view of the humidifier and dehumidifier used in a third embodiment.

FIG. 8 is a sectional side view through a third embodiment in a grand piano.

FIG. 9 is a schematic side view of a fourth embodiment, showing a vertical circulation of the air inside a grand piano.

FIG. 10 illustrates the stability of the relative air humidity inside a 213 cm long grand piano.

### DRAWINGS

### List of Reference Numbers

11 humidifier
12 dehumidifier
13 metal plate
14 bearings for 13
15a+b blower used to create circulating air streams 17 and 40
16a+b blower used for Humidifier 11 and 77, and for dehumidifier 12 and 78
17 circulating air stream in an upright piano
18 housing of an upright piano
19a-d wires
20 sound board (upright piano)
21 keyboard (upright piano)
22 pathway of air through humidifier 11
30 lid (humidifier and dehumidifier)
31 air inlet
32 sheet of material pervious to air
33 air outlet
34 sheet of flexible material
35 piece of tape
36 container (humidifier 11 and dehumidifier 12)
37 filling of humidifier 11 (water)
38 screws (to fix blowers 16a and 16b)
40 horizontally circulating air stream in grand pianos
45 wooden framework of grand piano
46 frame
47 aperture
48 board
49a+b brackets to fix humidifier 77 and dehumidifier 78
50 screw nuts to fix brackets 49a+b
51 screws used to attach frame 46 to framework 45
52 screws to fix brackets 49a+b
60 sound board of a grand piano
61 seal made of foam rubber
62 rigid sheet of plastic, used as lid for humidifier 77 and dehumidifier 78
64 cover for open end of housing 71 below sound board 60
66 blower to establish a vertically circulating air stream 69 in grand pianos
67 area below sound board 60 in grand pianos
68 area occupied by action 96 in grand pianos
69 pathway of air through dehumidifier 78
70 area above sound board 60 in grand pianos
71 housing of a grand piano
72 tube
74 hole in sound board 60
75 lid of a grand piano
76 tape of open cell foam
77 humidifier of third embodiment
78 dehumidifier of third embodiment
80 graph illustrating humidity of surrounding air
81 graph illustrating humidity of air inside a grand piano
82 area of graph 81, where humidity of surrounding air is high
83 area of graph 81, where humidity of surrounding air is low
91 strings
92 bridge
93 cast-iron frame in a grand piano
94 bearings of cast-iron frame 93
95 wooden wall separating areas 67 and 68
96 action of a grand piano

### DETAILED DESCRIPTION

### First Embodiment

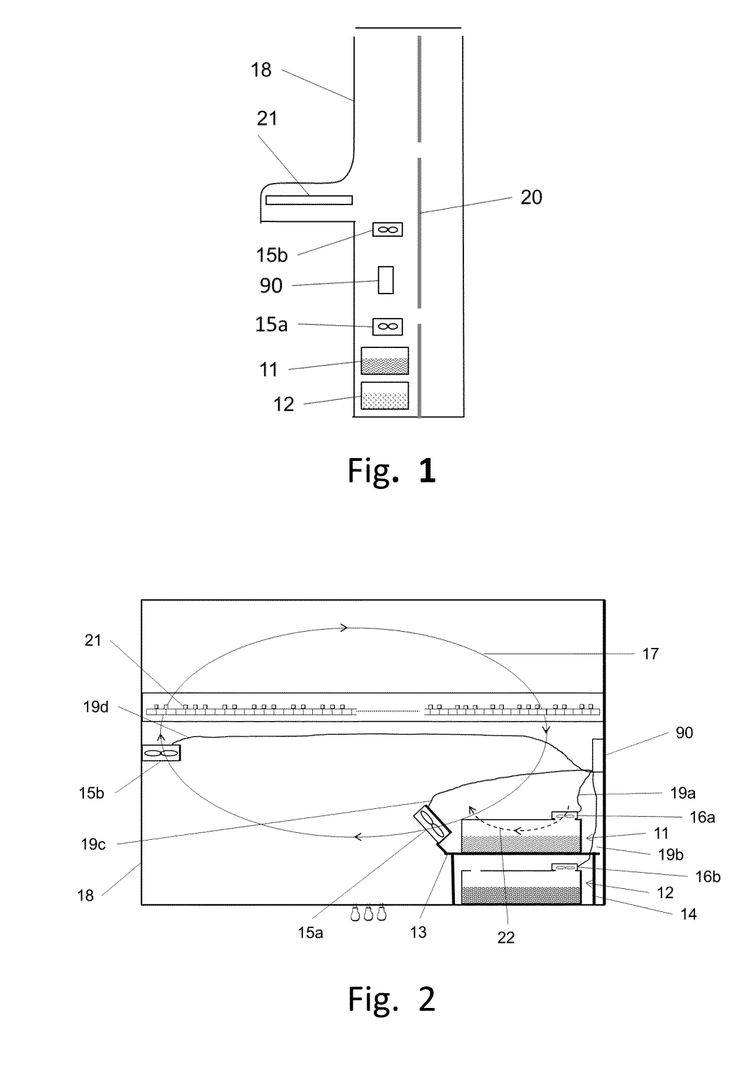

### FIGS. 1 to 3

In this embodiment all parts are mounted in front of sound board 20 and below of a keyboard 21 of an upright piano, like shown in FIG. 1. FIG. 2 is a front view and illustrates the position of the parts of a first embodiment. A dehumidifier 12 is placed on the bottom on the right side. A metal plate 13 supported by four bearings 14 is placed above dehumidifier 12 and a humidifier 11 is placed on top of it. A blower 15b is attached to the left and a hygrostat 90 to the right wall of housing 18. The left end of plate 13 is bent upward slightly and a blower 15a is attached to the bend part of plate 13. Blower 15a is considered to form an angle of about 45° with the bottom of housing 18, but different angles are also suitable. Blowers 15a and 15b are considered to be low noise computer case fans producing an air flow of 15 m³ per hour operated at 9 V, but higher or lower air flows can be used too.

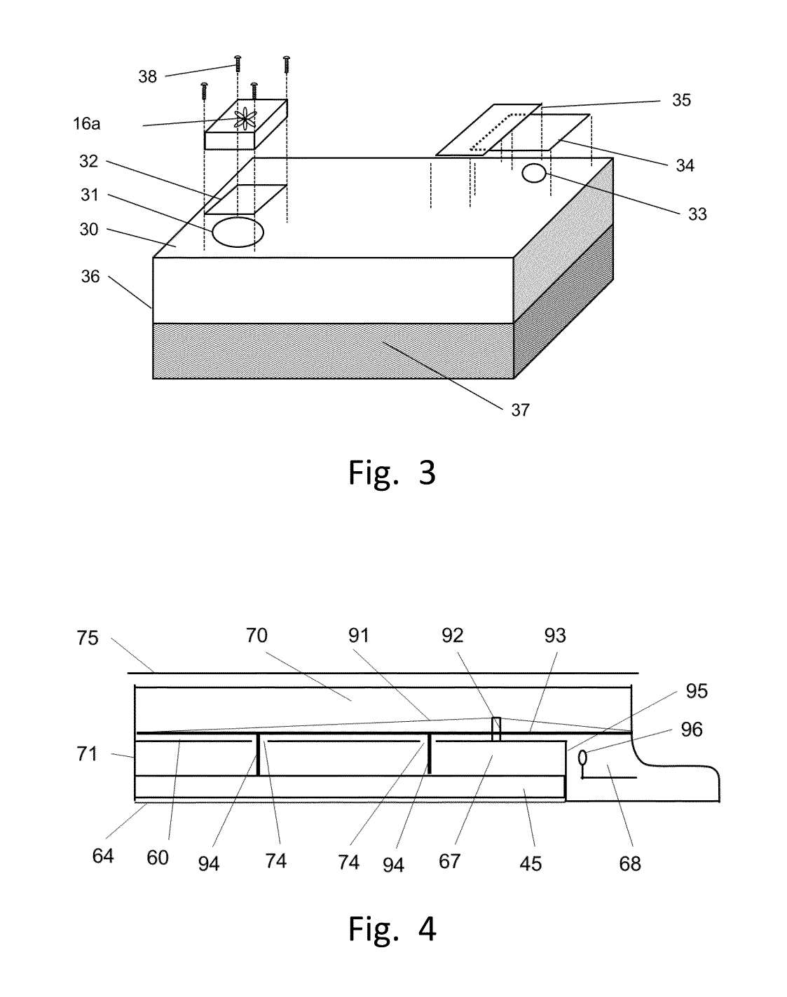

FIG. 3 shows the configuration of humidifier 11 and dehumidifier 12. I contemplate that both humidifier 11 and dehumidifier 12 are 30 cm long, 12 cm wide and 15 cm high, but other dimensions are possible too. Humidifier 11 consists of a container 36 with a substantially air-tight closing lid 30, which has an air inlet 31 and an air outlet 33. Air inlet 31 is covered with a sheet 32 of a material pervious to air and a blower 16a is attached to lid 30 with four screws 38. Despite sheet 32 is made of a 2 mm thick sheet of polyurethane foam containing 60 cells per inch, other materials pervious to air of different thickness can be used also. Blower 16a is a low noise computer case fan of 4 cm×4 cm in size and is considered to produce an air flow of 3.5 m³ per hour operated at 9 V, but other fans with higher or lower air flows can be used too. Air outlet 33 is covered with a rectangular sheet of flexible material 34 made of polyethylene, which is 3 cm×5 cm in size. Of course different flexible and lightweight materials than polyethylene and different sizes can be used. Sheet 34 is fixed at one edge to lid 30 with a piece of tape 35. Air forced through humidifier 11 by blower 16a lifts sheet 34, so that sheet 34 works like a flap valve. Container 36 is filled with water 37. A pathway of air 22 through humidifier 11 is shown in FIG. 2.

The configuration of dehumidifier 12 is quite identical to that of humidifier 11 but using blower 16b. Another difference is that dehumidifier 12 is filled with a desiccant. Although any customary desiccant can be used, calcium chloride has shown to work very well.

Blowers 16a, 16b, 15a and 15b each are connected to hygrostat 90 with wires 19a, 19b, a9c and 19d (FIG. 2). As a final step, small apertures in housing 18 are sealed with pieces of foam.

### OPERATION

### First Embodiment

The functionality of the method for controlling relative air humidity in pianos will first be shown at the example of low humidity in the surrounding air. Blowers 15a and 15b produce a continuous air stream 17, circulating air vertically throughout the piano, which results in relative air humidity being substantially consistent all about. When relative air humidity inside the piano falls to 49%, hygrostat 90 switches on blower 16a of humidifier 11. The air flow of blower 16a through humidifier 11 is reduced by sheet 32. In this way air gets humidified to about 80% to 100% and leaves humidifier 11 at a rate of about 5 l/min and gets mixed with air stream 17. Since the humidified air is also distributed throughout the piano by air stream 17, the humidity inside the piano begins to rise until the reference value of 50% is reached again and blower 16a is stopped by hygrostat 90 immediately. At high humidity levels in the surrounding air blower 16b of dehumidifier 12 gets activated by hygrostat 90 when humidity reaches 51% in the inside. Therefore, air dehumidified to about 30% leaving dehumidifier 12 is mixed with the air inside the piano by air stream 17 until the reference value of 50% is reached again. Of course different reference values than 50% and different threshold levels than 1% can be predetermined. For example humidity can be kept constant in the range of 44% to 46%. Thus in regions with usually low relative air humidity, the consumption of water can be reduced. On the other hand humidity can be kept constant in the range of 54% to 56%, which reduces the consumption of desiccant in regions, where the average relative air humidity is usually high. In this way the maintenance interval can be further extended.

Humidifier 11 and dehumidifier 12 are operated by hygrostat 90 split to the second, so no excess humidification and dehumidification respectively occurs. Thus water and desiccant is consumed only when air humidity leaves the range between 49% and 51%.

Only as less as about 0.1 g of water is required to increase the relative air humidity for 1% inside an average piano according to the above described method. Vice versa about 0.1 g of water has to be absorbed, to reduce the humidity for 1%. In addition sheet 32 and sheet 34 reduce consumption of water and desiccant substantially, while humidifier 11 and dehumidifier 12 are not active.

### DETAILED DESCRIPTION

### Second Embodiment

### FIGS. 4 to 6

The second embodiment concerns the application of the method for controlling humidity to a grand piano. The main parts of the grand piano are shown in FIG. 4. A lid 75 is attached to a housing 71. A sound board 60 and a wooden wall 95 both divide the interior of a grand into three areas: an area 67 below soundboard 60, an area 70 above soundboard 60 and an area 68, which is occupied by an action 96. A cast-iron frame 93 is supported by bearings 94, which are attached to a wooden framework 45 through holes 74 in sound board 60. Strings 91 are attached to cast-iron frame 93. The oscillations of strings 91 are transmitted to sound board 60 via a bridge 92. The open end of housing 71 below sound board 60 is covered with a moisture impervious sheet 64 according to U.S. Pat. No. 6,133,519.

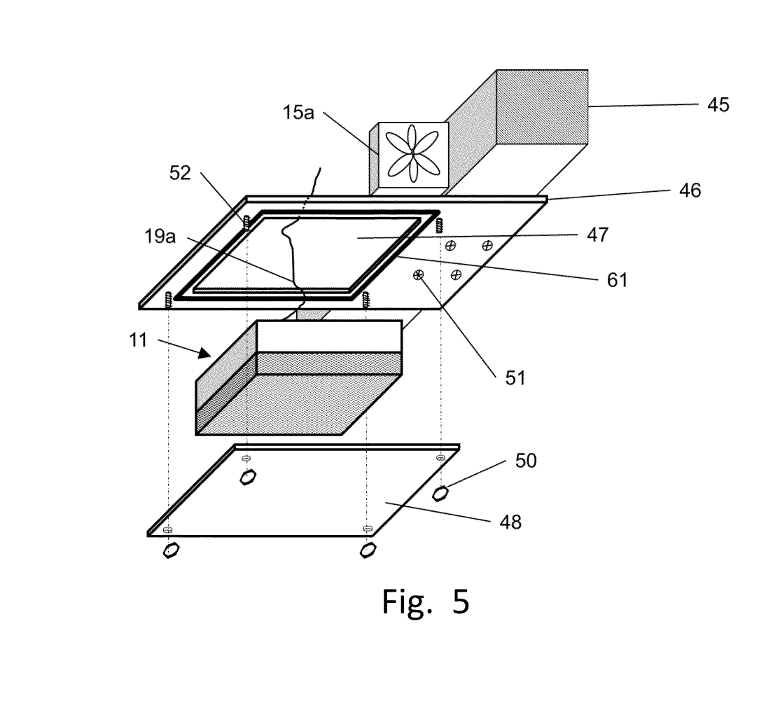

FIG. 5 is an exploded view showing how humidifier 11 and dehumidifier 12 are mounted to the wooden framework 45 below sound board 60. This is done by attaching a frame 46, with an aperture 47. Sheet 64 is attached to the edge of frame 46, so that aperture 47 is not closed by sheet 64 (not shown). Humidifier 11 can now be lifted into the piano by placing it on a board 48, which is just a little bigger than aperture 47. Board 48 is then fixed to the bottom of frame 46 with screws 52 and screw nuts 50. A seal 61 made of foam rubber allows board 48 and frame 46 to close substantially air tight. Dehumidifier 12 is mounted in the same way. Blowers 15a and 15b are attached to framework 45 of the grand piano, so that air is blown over the respective air outlet 33 of humidifier 11 and of dehumidifier 12, respectively.

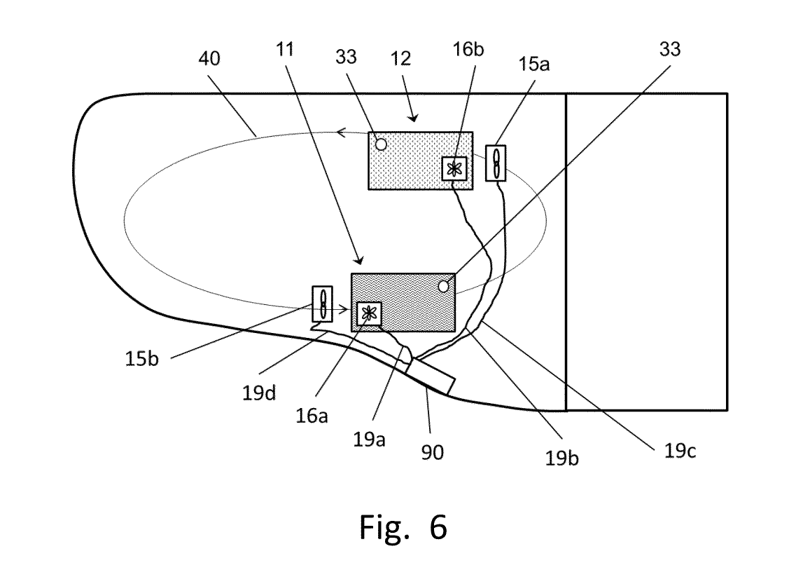

Humidifier 11 and dehumidifier 12 are mounted at different positions to framework 45, as shown in FIG. 6.

### OPERATION

### Second Embodiment

The functionality of the second embodiment is just the same as in the first embodiment, except that blowers 15a and 15b air generate a continuous air stream 40, which circulates horizontally below sound board 60 (FIG. 6). Thus humidified air produced by humidifier 11 and dehumidified air produced by dehumidifier 12 is rapidly mixed with the air inside the grand piano. The humidity of air leaving humidifier 11 at a rate of about 5 L/min is about 80% to 100%. This very moist air now gets mixed with air stream 40 produced by blowers 15a and 15b, which is about 250 L/min. Since the humidity of the air stream is about 49% when the humidifier starts working, the humidity of the resulting mixture is expected to be about 50%. This was proved by a humidity meter placed about 5 cm downstream air outlet 33 of humidifier 11. In this way the contact of very moist air with sound board 60 is prevented. This is a very important feature, since humidifier 11 is arranged directly below sound board 60 and very moist air otherwise could damage sound board 60 by the time. The functionality of dehumidifier 12 is exactly the same, apart from producing dehumidified air. Hence all characteristics of the first embodiment also apply for the second embodiment it could be achieved to keep air humidity inside a grand piano in a range of ±1% according to a preset reference value. Furthermore moisture level is kept substantially consistent in area 67.

### DETAILED DESCRIPTION

### Third Embodiment

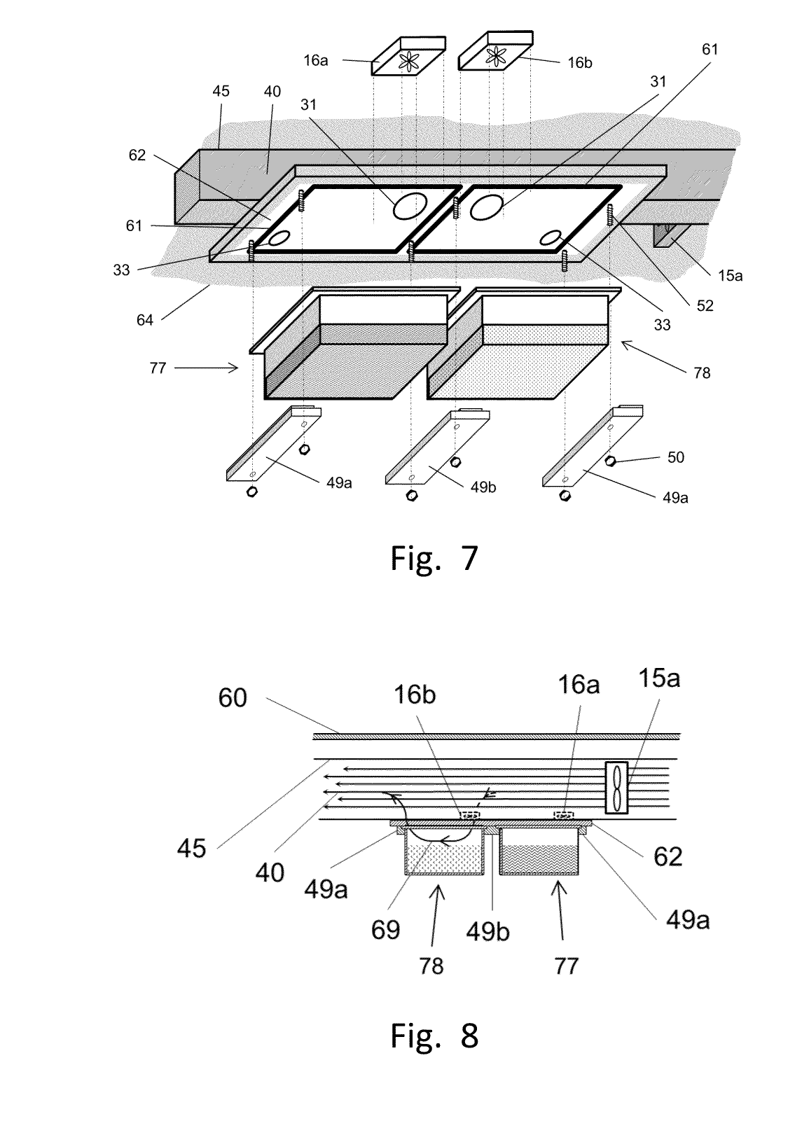

### FIG. 7

According to FIG. 7, the only difference of the third and the second embodiment is the way how a humidifier 77 and a dehumidifier 78 are mounted. A rigid sheet of plastic 62 is used as lid for both, humidifier 77 and dehumidifier 78. Sheet 62 is screwed to the wooden framework 45 of the grand piano and contains two air inlets 31 and two air outlets 33, one for humidifier 77 and one for dehumidifier 78, respectively. Air inlets 31 and air outlets 33 of sheet 62 are covered in the same way as air inlet 31 and air outlet 33 of humidifier 11 in FIG. 3 (not shown).

Humidifier 77 and dehumidifier 78 both are open containers and are pressed against sheet 62 by two clamps 49a and one clamp 49b, which are screwed to sheet 62 using screws 52 and screw nuts 50.

Two seals 61 are mounted to sheet 62 to enable sheet 62 to close the respective container of humidifier 77 and dehumidifier 78 substantially air tight. Two blowers 16a and 16b are attached to the respective air inlet 31. Air inlets 31 are covered with sheet material pervious to air 32 as in a first embodiment, according to FIG. 3. The same is true for air outlets 33 (FIG. 7). A blower 15a is attached to the wooden framework 45, blowing air over air outlets 33. Thus humidified and dehumidified air respectively is mixed with continuous air stream 40 produced by blower 15a. In small grand pianos blower 15b may be omitted. In grand pianos bigger than 213 cm blower 15b should be placed at the back end of area 67.

### OPERATION

### Third Embodiment

### FIG. 8

FIG. 8 shows the pathway of air 69 through dehumidifier 78 when the latter is switched on. Dehumidified air leaving dehumidifier 78 is mixed with a continuous air stream 40 produced by blower 15a. In this way the contact of very moist and very dry air respectively with sound board 60 is prevented, like it is in the second embodiment. Continuous air stream 40 of blower 15a also causes a consistent distribution of moisture. The advantage of this embodiment is that humidifier 77 and dehumidifier 78 can easily be refilled. Humidifier 77 and dehumidifier 78 can easily be pulled out when screw nuts 50 (FIG. 7) are unfastened, because the respective container is only fixed on the left and on the right side by clamps 49a and 49b. Thus maintenance is very comfortable.

### DETAILED DESCRIPTION

### Fourth Embodiment

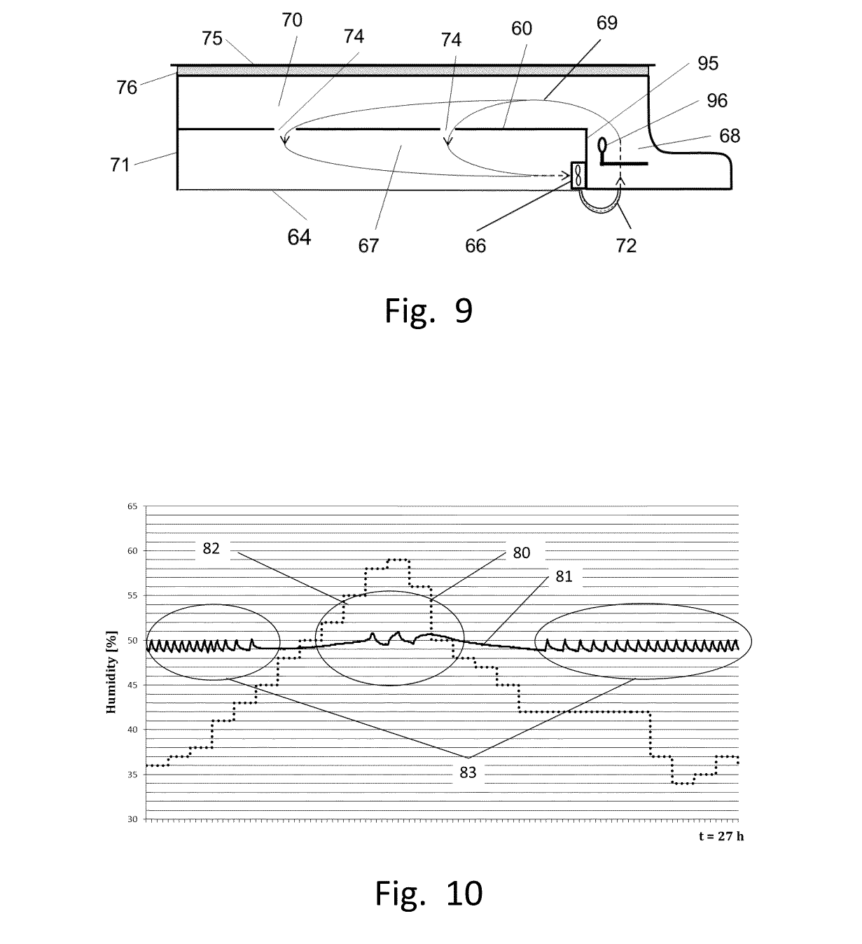

### FIG. 9

The fourth embodiment is exactly the same as the second or the third embodiment, except of an additional feature. This additional feature is shown in FIG. 9 and comprises another blower 66, which forces air from area 67 below sound board 60 into area 68 occupied by action 79 of a grand piano. In grand pianos areas 67 and 68 are separated by a wooden wall 95. Thus the connection between areas 67 and 68 is established by one or more plastic tubes 72, whereas tube 72 is connected to blower 66. Blower 66 is another fan of the same kind as used for humidifier 11 and dehumidifier 12 (FIG. 3). Tube 72 is considered to be made of polyvinylchloride, but different flexible materials can be used too. The diameter should be between 8 mm and 15 mm. Different diameters have shown to be insufficient or to result in a higher consumption of water and desiccant, respectively. Tube 72 is connected to area 67 through an aperture in cover 64 and to area 68 through a hole in the bottom of area 68. It showed to be useful to use two tubes 72, one connected to the left and side one to the right side of area 68. Area 70 is connected to area 67 by holes 74 in sound board 60.

### OPERATION

### Fourth Embodiment

Blower 66 blows humidity controlled air from area 68 below sound board 60 into area 69 occupied by action 96 via tube 72. The humidity controlled air mixes with the air inside area 69 and circulates back to area 67 via area 70 above sound board 60 and through holes 74. Of course it's also possible to use blower 66 to suck air through tube 72. In this case humidity controlled air from area 67 is forced to area 68 via area 70. Thus in addition to the horizontally circulating air stream 40 (FIG. 6) below sound board 60, blower 66 establishes a vertical circulation of air 69. This embodiment will only work properly, when lid 75 is closed. Finally the consumption of water and desiccant can be further reduced by substantially closing the gap between housing 71 and lid 75 with a thin seal tape 76 consisting of open cell foam.

In this embodiment it is possible for the first time to control the humidity in area 68. A Measurement in area 68 with a moisture meter showed humidity to be kept in a range of about ±2% around the average value. This implies the voicing of the hammer heads to be unchanged even if the humidity in the surrounding air varies.

In a region with high air humidity during summer (55% to 75%) and low air humidity during winter (25% to 40%), a consumption of 2.6 l of water and of 1.6 kg of calcium chloride has been observed. Since humidifier 77 has been charged with 3 l of water and humidifier 78 (FIG. 8) with 1.8 kg of calcium chloride, no maintenance was necessary during a whole year.

FIG. 10 shows the swing of relative air humidity inside a grand piano of 213 cm length during 27 hours. Graph 80 illustrates the relative air humidity of the surrounding air and Graph 81 illustrates the relative air humidity inside the grand piano. When humidity of the surrounding air is low, as can be seen in area 83, the air inside the piano gets humidified to about 50% any time it drops to 49%. Vice versa, when humidity of the surrounding air is high, as can be seen in area 82, the air inside the piano is dehumidified to about 50% any time moisture level reaches 51%. In this way the humidity inside the whole piano remains substantially consistent and can be kept in range of only ±1% around the reference value of 50%. This corresponds to a range of moisture content of sound board 60 (FIG. 4) of only about ±0.15% around the average value, thus the deviation of 1% (i.e. ±0.5%) according to U.S. Pat. No. 6,133,519 could be improved by a factor of three. Since the accuracy of the commercially available humidity meters suitable for measurements of moisture content of wood usually is ±0.1%, the swing of moisture content of ±0.15% couldn't be measured, because the signal to noise-ratio is less than 3. So the swing of moisture content of sound board 60 has to be taken from a Keylwerth-diagram for spruce (Thomas Trübswetter, Holztrocknung: Verfahren zur Trocknung von Schnittholz—Planung von Trocknungsanlagen, Carl Hanser Verlag, 2., aktualisierte Auflage, 6, Aug. 2009, page 25).

### DESCRIPTION AND OPERATION

### Fifth Embodiment

This embodiment is just the same as the fourth embodiment, except that lid 75 of the grand piano can also be opened. It is therefore necessary to close holes 74 in sound board 60 with foam and to mount another tube between areas 67 and 68. Air forced into area 68 by blower 66 is now circulated back to area 67 through this additional tube. In this way circulation of air through area 70 is prevented, reducing the consumption of water and desiccant, since humidity in area 70 can no longer be controlled, when lid 75 is opened.

### CONCLUSION, RAMIFICATIONS AND SCOPE

Thus the reader will see that at least one embodiment of the method for controlling the relative air humidity in pianos is a highly precise and energy saving method with strongly extended maintenance intervals. While my above description contains many specificities, these should not be construed as limitations on the scope, but rather as an exemplification of several embodiments thereof. Many other variations are possible. For example in an upright piano, humidifier 11 and dehumidifier 12 can be placed behind sound board 20, when the open end at the back side of the piano is sealed with a sheet made of a material impervious water according to U.S. Pat. No. 6,133,519. The arrangement of hygrostat 90, blowers 15a and 15b may be changed too. It is also possible to increase the output of humidified and dehumidified air by using two air inlets and two blowers 16a and for humidifier 11 and two blowers 16b for dehumidifier 12. In order to save energy blowers 15a and 15b can be switched off only when blowers 16a and 16b are not working. Tube 72 can be replaced by drilling a hole into wall 95 and attaching blower 66 to it.

In another embodiment only a humidifier is used. Despite air cannot be dehumidified, this may work in regions with usually low humidity of the surrounding. Of course it is possible to use only a dehumidifier in regions with usually high humidity of the surrounding.

Accordingly, the scope should be determined not by the embodiments illustrated, but by the appended claims and their legal equivalents.

1. A method for controlling relative air humidity in pianos and other small enclosed areas, comprising:
a) an apparatus for controlling air humidity inside said piano, and
b) at least one first blower generating an air-stream inside said piano, whereas humidified and dehumidified air, respectively gets distributed inside said piano by said first blower, resulting in air humidity being kept substantially consistent and substantially constant according to a predetermined value.

2. The method for controlling relative air humidity in pianos and other small enclosed areas of claim 1, wherein said apparatus for controlling air humidity comprises:
a) a hygrostat, and
b) a humidifier and/or a dehumidifier each consisting of a container with a closed bottom, upstanding side walls, and a substantially air tight closing lid comprising an air inlet and an air outlet, and
c) a second blower attached to said air inlet of said container, wherein said second blower forces air into said container and wherein said hygrostat operates said second blower,
d) a sheet of material pervious to air covering said air inlet, wherein said material pervious to air is sandwiched by said lid and said second blower, and
e) a sheet of flexible material impervious to air covering said air outlet, wherein said sheet of flexible material is fixed to said lid only at one side of said air outlet and thus works as a flap valve, and
f) a filling of said container selected from the group consisting of water, and a desiccant,
whereas a substantial reduction of consumption of said water and of said desiccant is achieved and whereas said hygrostat operates said humidifier and said dehumidifier split to the second, therefore extending maintenance interval significantly and enabling relative air humidity to be kept substantially constant according to a predetermined value.

3. The method for controlling relative air humidity in pianos and other small enclosed areas of claim 2, wherein
a) said desiccant is selected from the group consisting of calcium chloride, silica gel, molecular sieve, and superabsorbent polymer, and
b) said material pervious to air is selected from the group consisting of an open cell foam, a woven filter medium, and a fabric, and
c) said flexible material of said sheet working as a flap valve is selected from the group consisting of a polyethylene foil, a polypropylene foil, and a sheet of paper.

4. The method for controlling relative air humidity in pianos and other small enclosed areas of claim 3, wherein said piano is an upright piano comprising a vertically attached sound board and wherein said hygrostat, said humidifier, said dehumidifier, and said first blower are mounted in front of said sound board.

5. The method for controlling relative air humidity in pianos and other small enclosed areas of claim 3, wherein said piano is a grand piano comprising a horizontally attached sound board and wherein said hygrostat, said humidifier, said dehumidifier, and said first blower are mounted below said sound board.

6. The method for controlling relative air humidity in pianos and other small enclosed areas of claim 5, further including:
a) a connection between an area below said sound board and an area occupied by an action, and
b) a third blower, forcing humidity controlled air via said connection from said area below said sound board into said area occupied by said action,
whereas air in said area occupied by said action becomes humidity controlled.

7. A humidity controlled piano, comprising:
a) an apparatus for controlling air humidity inside said piano, and
b) at least one first blower generating an air-stream inside said piano,
humidified and dehumidified air, respectively gets distributed inside said piano by said first blower, resulting in air humidity being kept substantially consistent and substantially constant according to a predetermined value.

8. The humidity controlled piano of claim 7, wherein said apparatus for controlling air humidity comprises:
a) a hygrostat, and
b) a humidifier and/or a dehumidifier each consisting of a container with a closed bottom, upstanding side walls, and a substantially air tight closing lid comprising an air inlet and an air outlet, and
c) a second blower attached to said air inlet of said container, wherein said second blower forces air into said container and wherein said hygrostat operates said second blower,
d) a sheet of material pervious to air covering said air inlet, wherein said material pervious to air is sandwiched by said lid and said second blower, and
e) a sheet of flexible material impervious to air covering said air outlet, wherein said sheet of flexible material is fixed to said lid only at one side of said air outlet and thus works as a flap valve, and
f) a filling of said container selected from the group consisting of water, and a desiccant,
whereas a substantial reduction of consumption of said water and of said desiccant is achieved and whereas said hygrostat operates said humidifier and said dehumidifier split to the second, therefore extending maintenance interval significantly and enabling relative air humidity to be kept substantially constant according to a predetermined value.

9. The humidity controlled piano of claim 8, wherein
a) said desiccant is selected from the group consisting of calcium chloride, silica gel, molecular sieve, and superabsorbent polymer, and
b) said material pervious to air is selected from the group consisting of an open cell foam, a woven filter medium, and a fabric, and
c) said flexible material of said sheet working as a flap valve is selected from the group consisting of a polyethylene foil, a polypropylene foil, and a sheet of paper.

10. The humidity controlled piano of claim 9, wherein said piano is an upright piano comprising a vertically attached sound board and wherein said hygrostat, said humidifier, said dehumidifier, and said first blower are mounted in front of said sound board.

11. The humidity controlled piano of claim 9, wherein said piano is a grand piano comprising a horizontally attached sound board and wherein said hygrostat, said humidifier, said dehumidifier, and said first blower are mounted below said sound board.

12. A humidity controlled piano of claim 11, further including:
a) a connection between an area below said sound board and an area occupied by an action, and
b) a third blower, forcing humidity controlled air via said connection from said area below said sound board into said area occupied by said action,
whereas air in said area occupied by said action becomes humidity controlled.
